(19) United States
(12) Patent Application Publication
(10) Pub. No.: US 2015/0006330 A1
(43) Pub. Date: Jan. 1, 2015

(54) SYSTEM AND METHOD FOR REQUESTING FOOD FROM A VENDING MACHINE

(71) Applicant: Eran POLACK, Tel Aviv (IL)

(72) Inventor: Eran POLACK, Tel Aviv (IL)

(21) Appl. No.: 13/932,021

(22) Filed: Jul. 1, 2013

(51) Int. Cl. G06Q 30/06

(52) U.S. Cl. CPC G06Q 30/0635
USPC 705/26.81

(57) ABSTRACT

The subject matter discloses a vending machine comprising a transceiver for receiving a customer order from a remote computerized device, a food storage for storing fresh foods that are used to prepare the customer order; a food preparation unit to prepare the customer order; one or more serving stations to enable the customer to collect a prepared customer order, wherein the prepared customer order is prepared in the food preparation unit according to the customer order received by the vending machine. The subject matter also provides a computerized method for communicating with the vending machine.

### FIELD OF THE INVENTION

The subject matter relates generally to a system and method for requesting a food order from a vending machine using a mobile device and a computerized device.

### BACKGROUND OF THE INVENTION

Vending machines store products to be sold when a purchaser provides payment to the vending machine, e.g. inserting cash into a cash slot, or sliding a credit card through a card reader. Once the payment is accepted, the purchaser selects a desired product, for example, a can of soda or a snack. The vending machine receives the selection and provides the purchaser with the desired product at a serving port, from which the purchaser collects the desired product. The customer is required to access the vending machine, for example by physically approaching the vending machine when inserting the cash or sliding the credit card.

Customers are able to order goods and products from businesses such as restaurants and grocery stores through computers and mobile devices at a different location from where the customer is located and retrieve the ordered goods at a later time. The stores may have a website, a telephone number or an application from which the order can be made. The consumers can validate their identity when picking up the order by showing a valid identification, such as a driver's license at the location where the pickup occurs.

### SUMMARY

It is an object of the subject matter to disclose a method performed on a server that communicates with a vending machine. The method provides for receiving a customer order from a remote computerized device, wherein the customer order comprises a food product purchased by a customer using the remote computerized device; selecting a vending machine from a plurality of vending machines for providing the food product the customer is ordering; transmitting the customer order to a selected vending machine; transmitting a location of the selected vending machine to the remote computerized device.

In some cases, the method further comprises receiving a time estimate from the vending machine, wherein the time estimate is a time in which the customer order is ready for the customer to collect and transmitting the time estimate to the remote computerized device. In some cases, the method further transmitting an authorization code to the remote computerized device. In some cases, the method further authenticating the customer when the customer is at the location of the vending machine. In some cases, the vending machine is at the location determined by the customer.

It is another object of the subject matter to disclose a method performed on a vending machine, comprises receiving a customer order from a server, wherein the customer order comprises a food product that is prepared by the vending machine; preparing the customer order, wherein the customer order is freshly made using fresh food in the vending machine; serving a prepared customer order to a customer at a serving station, wherein the prepared customer order is prepared according to the customer order received by the vending machine.

In some cases, the method further comprises storing the customer order until the customer provides an authentication code to the vending machine; serving the customer order responsive to receiving the authentication code from a remote computerized device associated with the customer. In some cases, the authentication code is received through near field communication between the remote computerized device and the vending machine. In some cases, the authentication code is scanned onto an authorization unit on the vending machine.

It is another object of the subject matter to disclose a vending machine, comprising a transceiver for receiving a customer order from a remote computerized device operated by a customer; a food storage for storing fresh foods that are used to prepare the customer order; a food preparation unit to prepare the customer order; one or more serving stations to enable the customer to collect a prepared customer order, wherein the prepared customer order is prepared in the food preparation unit according to the customer order received by the vending machine.

In some cases, the vending machine further comprises an authentication unit for receiving an authentication code from a mobile device of the customer, wherein an authentication identifies the mobile device and generates a command to a serving station of the one or more serving stations to serve the customer order. In some cases, the authentication unit receives the authentication code by near field communication. In some cases, the authentication unit receives the authentication code from scanning the mobile device. In some cases, the food storage comprises a refrigeration unit, a freezer unit, and a combination of both.

In some cases, the vending machine further comprises a prepared food storage to store the prepared customer order until the customer collects the prepared customer order at the one or more serving stations. In some cases, the one or more serving stations is two or more serving stations, wherein the customer receives an identification value relevant for a serving station of the two or more serving stations that contains the prepared customer order.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows an environment for a customer to make a customer order to a vending machine, according to some exemplary embodiments of the subject matter;

FIG. 2 shows a server for communicating between a mobile device and a vending machine, according to some exemplary embodiments of the subject matter;

FIG. 3 shows a mobile device application for ordering from a vending machine, according to some exemplary embodiments of the subject matter;

FIGS. 4A-4B show a vending machine for vending a customer order of a mobile device, according to some exemplary embodiments of the subject matter;

FIG. 5 shows a method performed on server for communicating between a mobile device and a vending machine, according to some exemplary embodiments of the subject matter;

FIG. 6 shows a method performed on a vending machine for providing a customer order received from a mobile device, according to some exemplary embodiments of the subject matter; and,

FIG. 7 shows a customer ordering a customer order from a vending machine, according to some exemplary embodiments of the subject matter.

### DETAILED DESCRIPTION

The subject matter discloses a system and method for requesting a customer order from a vending machine using a mobile device, according to exemplary embodiments.

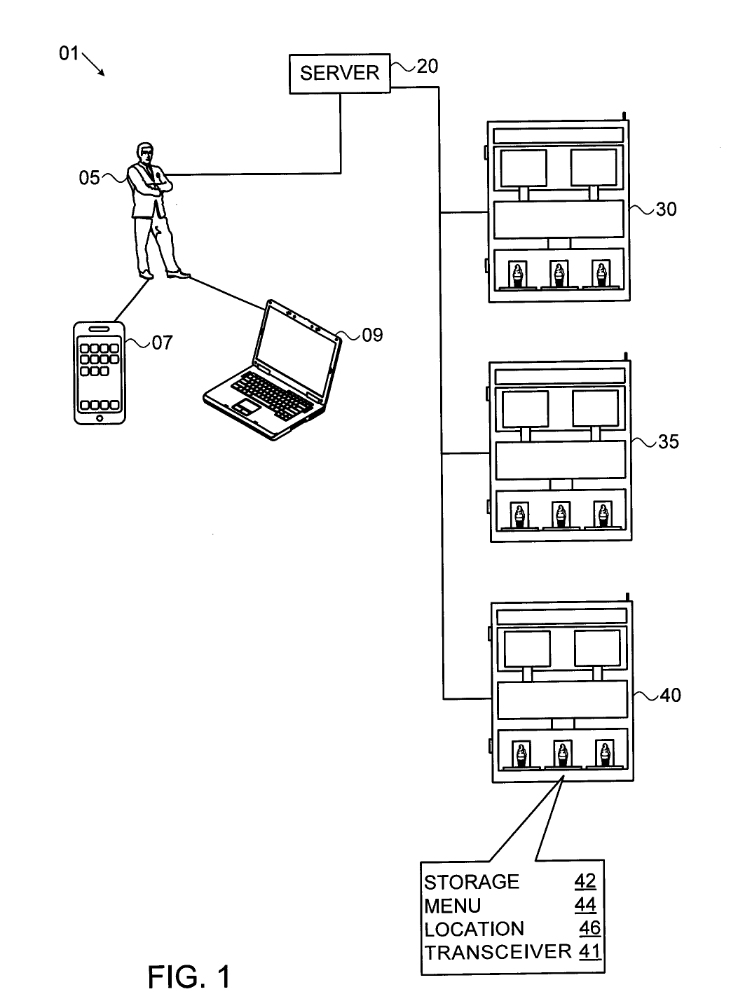

FIG. 1 shows an environment for a customer to make a customer order to a vending machine, according to some exemplary embodiments of the subject matter. The environment 01 shows a customer 05 using a mobile device 07 or a computerized device 09, such as a home computer, to create a customer order, which comprises a food product that the customer 05 wishes to purchase. The customer order may be created using a computerized interface associated with a company that operates the vending machine, for example a dedicated website or a mobile application. The customer order is transmitted to a server 20, which communicates with a plurality of vending machines 30, 35, 40. The server 20 selects a vending machine 40 of the plurality of vending machines 30, 35, 40, which prepares the product in the customer order. The vending machine 40 comprises a transceiver 41 for receiving the customer orders from the server 20. The vending machine 40 comprises a storage 42 for storing products to be dispensed to the customer 05. The vending machine 40 may also include an interface 44 for enabling a customer that physically approach the vending machine 40 to select a product from a list of products. The product stored in the storage 42 may be a freshly prepared food, required to produce the order sent by the customer 05. The vending machine 40 prepares the customer order to be prepared according to the customer order to a customer's satisfaction. For example, the customer 05 orders a customer order for a freshly prepared pizza, with custom toppings, such as mushrooms, peppers and goat cheese. The vending machine 40 prepares the customer order to produce the food product in the manner the customer would like the food product.

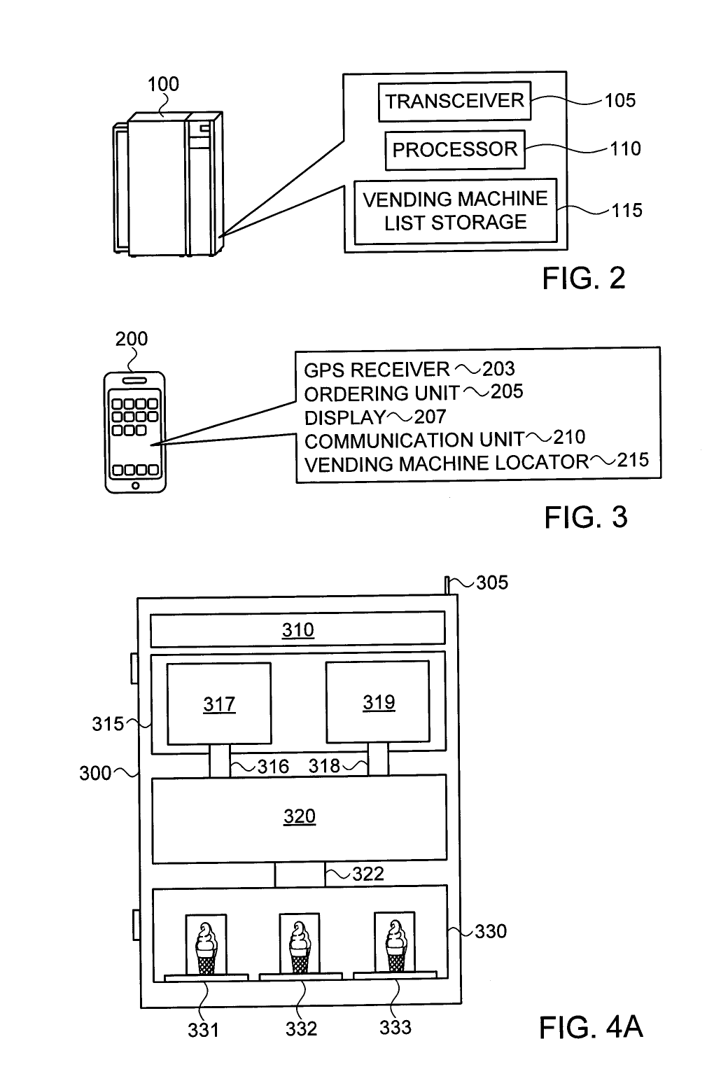

FIG. 2 shows a server for communicating between a customer and a vending machine, according to some exemplary embodiments of the subject matter. The server 100 comprises a transceiver 105 for receiving a customer order from the mobile device, which is used by the customer 05 of FIG. 1 to create the customer order. The customer order comprises a food product that the customer 05 of FIG. 1 of the mobile device wants to purchase from the vending machine, which sells the food product. The transceiver 105 transmits the customer order received from the mobile device to the vending machine. The server 100 comprises a processor 110, which selects the vending machine that produces the customer's order. The selected vending machine may be the vending machine that is located closest to a predefined customer's location. The predefined customer's location may be based on a location inputted by the customer when ordering the food product, or according to a mobile device associated with the customer. The selection of the vending machine may also take into account the inventory of each of the vending machines, the availability of producing the product and the like. For example, the server may communicate with 12 vending machines, and only 4 of which have technical capabilities to produces the food products ordered by the customer. In some exemplary embodiments of the subject matter, the processor 110 may create an authorization code, which is transmitted to the customer's PC or mobile device and to the vending machine. The authorization code enables the vending machine to authenticate a customer's identity prior to serving the customer order to the customer, which prevents the wrong customer or a passerby from taking the customer order.

The server 100 transmits the customer order to the selected vending machine. The server 100 comprises a vending machine list storage 115, which comprises a vending machine list of the vending machine locations. For example, the vending machine list storage 115 comprises the list of the vending machines located in a bus station as well as the particular location of each vending machine within the bus station. The vending machine list may further comprise the type of products sold in each vending machine, such as which vending machines produce frozen yogurts, which vending machines produce pizza and the like. The processor 110 may obtain information about the vending machine from the vending machine list storage 115 to select the vending machine that comprises the food product the customer is ordering.

FIG. 3 shows a mobile device for ordering from a vending machine, according to some exemplary embodiments of the subject matter. The mobile device 200 comprises an ordering unit 205, which enables the customer 05 of FIG. 1 using the mobile device 200 to designate a food product that the customer 05 wants to purchase from the vending machine. The mobile device 200 comprises a communication unit 220, which may be used to authenticate the mobile device 200 to enable the customer 05 to pick up a prepared customer order from the vending machine. The mobile device 200 may receive an authentication code from the server 20 of FIG. 1, which is provided to the vending machine before the vending machine serves the customer order to the customer. The communication unit 220 may communicate the authentication code to the vending machine using Bluetooth or near field communication when the customer approaches the vending machine, or scan the authentication code in of a scanner of the vending machine.

The mobile device may comprise a location unit 230, which directs the customer 05 to the location of the vending machine selected by the server. The server sends the location of the selected vending machine to the mobile device 200. The location unit 230 may communicate with a display device 207 of the mobile device. The display device 207 displays data received from the location unit 230, such as the location of the selected vending machine in a designated area, for example, displaying the location of the selected vending machine inside an airport terminal. The mobile device 200 may comprise a GPS receiver 203, which determines a customer location for the customer 05 carrying the mobile device 200, for example by providing the GPS coordinates of the customer 05. The customer location may be transmitted to the server 20 of FIG. 1, to determine the distance of the customer from the vending machine. In some cases, the customer location is used by the server 20 to authenticate a customer's identity before the vending machine serves the customer 05 a prepared customer order.

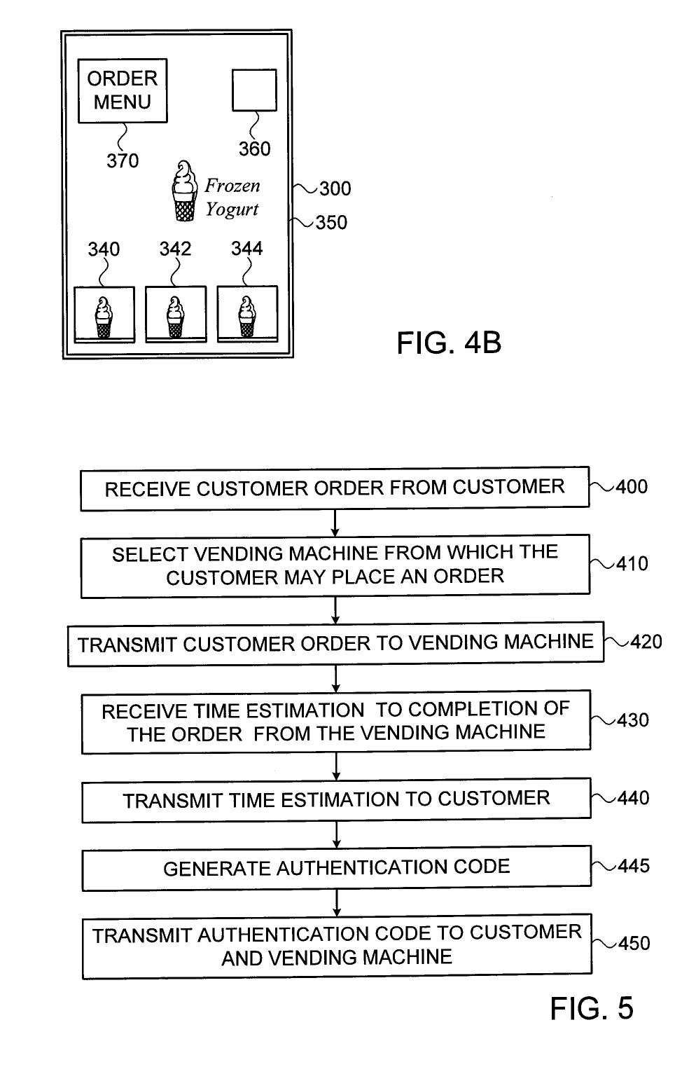

FIG. 4A shows a mechanical structure of a vending machine for vending a customer order received from a remote computerized device, according to some exemplary embodiments of the subject matter. The vending machine 300 comprises a transceiver 305 for receiving customer orders from the server 100 of FIG. 2. The customer orders are transferred from the transceiver 305 to a vending machine processor 310. The vending machine processor 310 determines a time estimation of a waiting time before the food product is produced. In some cases, the time estimation is sent to the customer's remote computerized device, and only if the customer approves the product, the vending machine processor 310 transmits the customer order to a food preparation unit 320, which prepares the customer order for the customer 05 of FIG. 1.

The vending machine comprises a food storage 315, which stores fresh food products to prepare the customer order. In some exemplary embodiments of the subject matter, the food storage 315 may comprise a refrigerating unit 317 for storing the fresh food products, which may require refrigeration, for example fruits or dairy products. In other exemplary embodiments of the subject matter, the food storage 315 may comprise the refrigerating unit and a freezer unit 319, which enables storing the fresh food products in separate temperatures. For example, the food storage 315 may store nuts and condiments in the refrigerating unit 317 and ice cream in the freezer unit 319. In some cases the food storage comprises the refrigerating unit 317, in the freezer unit 319, or a combination of both.

The fresh food products are transferred from the food storage 315 to the food preparation unit 320, which prepares the customer order. The fresh food products in the refrigeration unit 317 may be transferred to the food preparation unit 320 through a refrigeration track 316, such as a conveyer belt a moveable claw, or the like. The fresh food products in the freezer unit 319 may be transferred to the food preparation unit 320 through a freezer track 318, such as a conveyer belt, a moveable claw, or the like. The products may be moved using a gripping unit. For example, the customer order is for a vanilla flavored frozen yogurt with peaches and a garnish of walnuts. The frozen yogurt is transferred from the freezer unit 319 to the food preparation unit 320 on the freezer track 318, and the peaches are transferred from the refrigeration unit 317 on the refrigeration track 316 to the food preparation unit 320. The food preparation unit 320 may comprise a blender, which receives and mixes the frozen yogurt and the peaches together. Once the blender completes mixing the frozen yogurt and the peaches are poured into a serving dish. The food preparation unit 320 then sprinkles the walnuts received from the refrigeration unit 317 on top of the frozen yogurt and the peaches. The serving dish is sealed with a cover to preserve the freshness of a prepared customer order, which is then transferred from the food preparation unit 320 to a prepared food storage 330 through a prepared food conveyer 320. The fresh food conveyer 322 may be a conveyer belt, a claw to carry the prepared customer order, or the like. The prepared food storage 330 stores the prepared customer order until the customer 05 of FIG. 1 collects the prepared customer order.

The prepared storage 330 may be regulated in a temperature that maintains the prepared customer order. For example, the prepared food storage 330 is at 0 degrees Celsius for storing the ice cream. In other exemplary embodiments, the prepared food storage 330 may place the prepared customer orders in three row compartments 331, 332, 333. The row compartments 331, 332, 333 store the prepared customer orders such that the customer can easily pick up the order. For example, each row compartment of the row compartments 331, 332, 333 comprises a conveyer belt (not shown) that moves the customer orders to a serving station where the customer may pick up the customer order. Each row may comprise multiple compartments, where each compartment of the multiple compartments stores a single prepared customer order. The vending machine processor 310 stores the location of each prepared customer order in the multiple compartments, for example in a matrix, which enables quick retrieval of the prepared customer order when the customer wants to pick up the prepared customer order.

FIG. 4B shows a view of the vending machine, according to some exemplary embodiments of the subject matter. The vending machine 300 comprises a cover 350, which may show an advertisement for food products sold in by the vending machine 300. The vending machine comprises one or more serving stations 340, 342, 344, which enables the vending machine 300 to serve multiple customers at the same time. The prepared customer order is transferred from the prepared food storage 330 to the serving stations 340, 342, 344 on a serving conveyer (not shown), which may be a conveyer belt, a claw to carry the prepared customer order, a gripping mechanism or the like. The vending machine 300 may comprise an authentication unit 360, which authenticates a customer's identity prior to serving the prepared food. The authentication may be performed through near field communication of the mobile device 200 of FIG. 3 when the mobile device enters a near field range of the vending machine 300. In other cases, the authentication unit 360 may comprise a scanner for scanning an image displayed on the mobile device 200. The vending machine 300 may comprise a graphic interface order menu 370 to enable the customer 05 to make the customer order by approaching the vending machine 300 without using the mobile device 200 or the computerized device 09 of FIG. 1.

FIG. 5 shows a method performed on a server for communicating between a remote computerized device of a customer and a vending machine, according to some exemplary embodiments of the subject matter. Step 400 discloses receiving a customer order from the customer 05 of FIG. 1, for example via the mobile device 07 of FIG. 1 or via the computerized device 09 of FIG. 1. The customer order comprises a food product that the customer 05 wants to purchase from a vending machine, such as vending machine 300 of FIG. 4A. Step 410 discloses the server selecting the vending machine from which the customer 05 may purchase the customer order from a vending machine list. The server selects the vending machine from the vending machine list stored in the server. The list of vending machines comprises locations of the vending machines as well as food products sold or produced by the vending machines. The list of vending machines may also include data regarding the current inventory of products in each vending machine, which effects the selection of the vending machine. The server 100 selects the vending machine according to the customer order by comparing food products of the customer order with food products available at each vending machine, according to the data stored in the list of vending machines. The server 100 finds the vending machine with matching food products and selects the vending machine and designates it to prepare the food order.

Step 420 discloses transmitting the customer order to the selected vending machine. The server 100 transmits the customer order to the vending machine selected from the list of vending machines. Step 430 discloses receiving a time estimation from the selected vending machine regarding a time estimation to complete the customer order. Step 440 discloses transmitting the time estimation to the customer 05 for approval before instructing the selected vending machine to prepare the ordered food product. The time estimation informs the customer 05 how much time is required by the vending machine to complete preparing the customer order.

Step 445 discloses generating an authentication code. In some exemplary embodiments of the subject matter, the server 100 may generate the authentication code, which the customer 05 provides to the vending machine as a condition for the vending machine to serve the customer 05 a prepared customer order. Step 450 discloses transmitting the authentication code to the customer 05 and to the vending machine 300 to enable the vending machine 300 to authenticate the customer 05 when the customer 05 wishes to pick up the prepared customer order. Step 460 discloses authenticating the customer 05 when approaching the selected vending machine. In some exemplary embodiments of the subject matter, the server 100 authenticates the customer 05 by determining that the customer's location is at a predetermined distance from the selected vending machine. For example, the server 100 authenticates the customer by comparing a customer GPS location, obtained from the mobile device 07 with a GPS location of the vending machine stored at the vending machine list of the server. In some cases, the customer receives an identification value relevant to for a serving station of the two or more serving stations that contains the prepared customer order, such that the customer is able to determine at which serving station the customer order will be served.

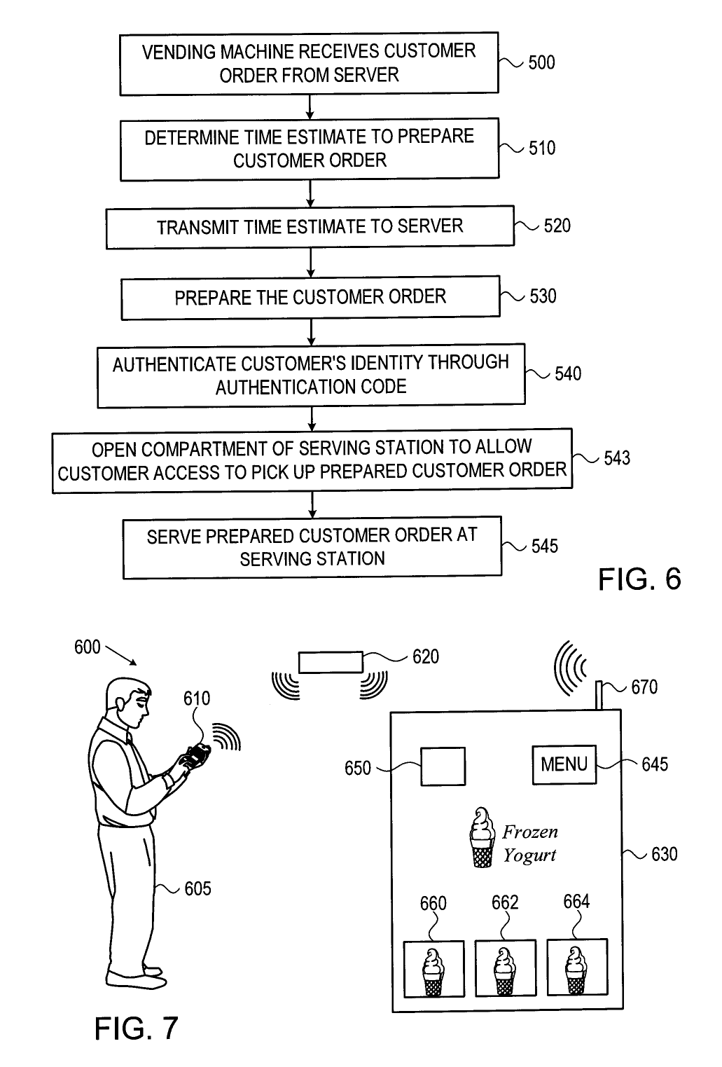

FIG. 6 shows a method performed on a vending machine for providing a customer order received from the customer 05 of FIG. 1, according to some exemplary embodiments of the subject matter. Step 500 discloses the selected vending machine receiving the customer order from the server. Step 510 discloses determining a time estimate of preparing the customer order. The vending machine 300 may place the customer order in a customer order queue. The vending machine processor determines the time estimate according to a number of customer orders that are pending on the selected vending machine prior to the customer order received in step 500. For example, where the vending machine 300 requires 2 minutes to prepare each food product and the vending machine has five customer orders before the customer order, the vending machine processor 310 determines a ten minute time estimate. Step 520 discloses transmitting the time estimate to the server 100 to inform the customer 05 of FIG. 1.

Step 530 discloses preparing the customer order. The vending machine processor 310 determines from the customer order which ingredients are required from the food storage 315 of FIG. 4A. The ingredients are transferred to the food preparations unit 320 of FIG. 4A. For example, the customer order is requesting chocolate and strawberry ice creams with cherries on top. The vending machine processor 310 commands the food storage 315 to transfer the chocolate and strawberry ice cream from the freezer unit 319, and the cherries from the refrigeration unit 317 to the food preparations unit 320. The food preparation unit 320 mixes the products together and places a prepared customer order into a serving container, which may be a plate or cup used by the customer to have the prepared customer order. The serving plate may comprise a cover, which is attached to the serving plate to prevent the prepared customer order from spilling when the customer 05 carries it. Step 540 discloses storing a prepared customer order. The food preparation unit 320 mixes the products together and places the prepared customer order in the prepared food storage 330 of FIG. 4A where the prepared customer order is stored until the customer picks up the prepared customer order.

The prepared storage 330 may be regulated in a temperature that maintains the prepared customer order. For example, the prepared food storage 330 is at 0 degrees Celsius for storing the ice cream. The prepared storage 330 may arrange prepared customer orders in multiple compartments, which enable easy transfer of the prepared customer order from the prepared food storage 330 to the serving stations 340, 342, 344 of FIG. 4B. For example, the prepared customer food is picked up by a mechanical claw and transferred from a compartment of the multiple compartments and moved to one of the serving stations 340, 342, 344.

Step 540 discloses authenticating the customer's identity through the authentication code. In some cases, the vending machine 300 provides the customer 05 with an authentication code, which the customer provides the vending machine 300 before the vending machine 300 serves the customer 05 the prepared customer order. The authentication code may be received by the vending machine 300 through near field communication or other wireless communication signals. In some exemplary embodiments of the subject matter, the customer 05 scans an image or types a code onto the authentication unit 360 of FIG. 4B. Step 543 discloses opening a compartment of the serving stations allowing the customer 05 access. Step 545 discloses serving the prepared customer order at a serving station. The vending machine 300 transfers the prepared customer order from the prepared food storage 330 to one of the serving stations. Once the vending machine 300 receives the authentication code, the vending machine 300 generates a command to a serving station of the one or more serving stations to serve the customer order.

FIG. 7 shows a customer ordering a customer order from a vending machine, according to some exemplary embodiments of the subject matter. The customer 605 orders the customer order using a mobile device 610 or using a PC (not shown). The customer order is transmitted to a server 620, which selects a vending machine 630 that sells a food product requested by the customer 600 in the customer order. Once the server 620 selects the vending machine 630, the server 620 transmits the customer order to the selected vending machine 630. The vending machine 630 receives the customer order through a transceiver 640. The vending machine 630 prepares the customer order and stores a prepared customer order in the prepared food storage 330 of FIG. 4A. The vending machine 630 comprises serving stations 660, 662, 664, from which the customer 605 may pick up the prepared customer order. The vending machine 630 may transmit a message to the customer 605 when the customer order is prepared and ready to be picked up by the customer 605. The vending machine 630 may comprise an authorization unit 650, which requires the customer 605 to scan the mobile device 610 before the vending machine 630 serves the customer prepared food at one serving station of the serving stations 660, 662, 664.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A method performed on a server, comprises:
receiving a customer order from a remote computerized device, wherein the customer order comprises a food product purchased by a customer using the remote computerized device;
selecting a vending machine from a plurality of vending machines for providing the food product the customer is ordering;
transmitting the customer order to a selected vending machine;
transmitting a location of the selected vending machine to the remote computerized device.

2. The method of claim 1, further comprises:
receiving a time estimate from the vending machine, wherein the time estimate is a time in which the customer order is ready for the customer to collect;
transmitting the time estimate to the remote computerized device.

3. The method of claim 1, further comprises transmitting an authorization code to the remote computerized device.

4. The method of claim 1, further comprises authenticating the customer when the customer is at the location of the vending machine.

5. The method claim 1, wherein the vending machine is at the location determined by the customer.

6. A method performed on a vending machine, comprises:
receiving a customer order from a server, wherein the customer order comprises a food product that is prepared by the vending machine;
preparing the customer order, wherein the customer order is freshly made using fresh food in the vending machine;
serving a prepared customer order to a customer at a serving station, wherein the prepared customer order is prepared according to the customer order received by the vending machine.

7. The method of claim 6, further comprises:
storing the customer order until the customer provides an authentication code to the vending machine;
serving the customer order responsive to receiving the authentication code from a remote computerized device associated with the customer.

8. The method of claim 7, wherein the authentication code is received through near field communication between the remote computerized device and the vending machine.

9. The method of claim 7, wherein the authentication code is scanned onto an authorization unit on the vending machine.

10. A vending machine, comprising:
a transceiver for receiving a customer order from a remote computerized device operated by a customer;
a food storage for storing fresh foods that are used to prepare the customer order;
a food preparation unit to prepare the customer order;
one or more serving stations to enable the customer to collect a prepared customer order, wherein the prepared customer order is prepared in the food preparation unit according to the customer order received by the vending machine.

11. The vending machine of claim 10, further comprises an authentication unit for receiving an authentication code from a mobile device of the customer, wherein an authentication identifies the mobile device and generates a command to a serving station of the one or more serving stations to serve the customer order.

12. The vending machine of claim 11, wherein the authentication unit receives the authentication code by near field communication.

13. The vending machine of claim 11, wherein the authentication unit receives the authentication code from scanning the mobile device.

14. The vending machine of claim 10, wherein the food storage comprises a refrigeration unit, a freezer unit, and a combination of both.

15. The vending machine of claim 10, further comprising a prepared food storage to store the prepared customer order until the customer collects the prepared customer order at the one or more serving stations.

16. The vending machine of claim 10, wherein the one or more serving stations is two or more serving stations, wherein the customer receives an identification value relevant for a serving station of the two or more serving stations that contains the prepared customer order.
